(19) United States
(12) Patent Application Publication
(10) Pub. No.: US 2024/0183384 A1
(43) Pub. Date: Jun. 6, 2024

(54) RADIAL FOIL BEARING WITH MUTLIPLE BEARING SURFACES, CONTACT ANGLE DEFINITION

(71) Applicant: Schaeffler Technologies AG & Co. KG, Herzongenaurach (DE)

(72) Inventors: Jürgen Hilbinger, Neustadt/A. (DE); Wolfgang Braun, Garstadt (DE); Andre Anger, Uehlfeld (DE)

(73) Assignee: Schaeffler Technologies AG & Co. KG, Herzogenaurach (DE)

(21) Appl. No.: 18/285,848

(22) PCT Filed: Mar. 30, 2022
(86) PCT No.: PCT/DE2022/100246

§ 371 Date: Oct. 5, 2023

(30) Foreign Application Priority Data
Apr. 9, 2021 (DE) 10 2021 108 883.6

(51) Int. Cl. F16C 17/02; F16C 43/02

(52) U.S. Cl. CPC F16C 17/024; F16C 43/02

(57) ABSTRACT

A radial foil bearing operable in a single rotational direction includes an outer ring and a plurality of foil packs. Each foil pack has a top foil and a corrugated foil arranged radially between the outer ring and the top foil. Each top foil has a first end fixed to the outer ring and a second end, opposite the first end, that is freely movable and overlaps a circumferentially adjacent top foil. A predetermined angular range of the second end is arranged to contact a shaft.

### CROSS-REFERENCE TO RELATED APPLICATIONS

This application is the United States National Phase of PCT Appln. No. PCT/DE2022/100246 filed Mar. 30, 2022, which claims priority to German Application No. DE102021108883.6 filed Apr. 9, 2021, the entire disclosures of which are incorporated by reference herein.

### TECHNICAL FIELD

The present disclosure relates to a radial foil bearing with multiple bearing surfaces.

### BACKGROUND

Radial foil bearings are intended for the aerodynamic mounting of shafts, where a load-bearing gas/air cushion is formed between the shaft and the radial foil bearing. The mode of operation is similar to that of a hydrodynamic fluid bearing, but with the difference that the shaft is supported by the radial foil bearing via an air cushion and not by a fluid cushion of a hydrodynamic fluid bearing. Both functional forms have in common that only the rotational motion of the shaft leads to the formation of the load-bearing cushion.

Foil bearings differ from conventional aerodynamic bearings in that they have a flexible, elastic structure between the rotating shaft and the stationary housing component. This feature means that although they exhibit a lower stiffness than conventional air bearings, they can adapt to geometric changes in the air gap caused, for example, by misalignment errors of the bearing seats or differing thermal expansion of the shaft and housing, thus enabling higher operational reliability in practice in many applications.

To form the load-bearing air cushion, the radial foil bearing usually has a top foil in contact with the stationary shaft and a corrugated foil arranged radially between the top foil and the outer ring of the bearing, which can elastically deflect in the radial direction. Thus, in principle, the radial foil bearing has two foils in contact with one another and an outer ring supporting the foils so that the radial foil bearing can be received in a housing. The outer ring can also be formed integrally with the housing, in which the foils of the radial foil bearing are inserted.

If the shaft is set in rotational motion relative to the radial foil bearing, the air present in the air gap defined by the standstill is displaced. Above a certain speed of the shaft, an air cushion forms between the top foil and the shaft on which the shaft can slide. In this regard, the foil pack with its corrugated foil and radial spring effect ensures that fluctuations in air pressure or vibrations of the shaft in the radial direction do not affect the bearing and thus keep the air cushion load-bearing.

In the prior art, a variety of designs of foil bearings are known. In addition to radial foil bearings, there are also axial foil bearings that can provide an axial load-bearing capacity. The arrangement of the foils of the bearing as well as their geometric design are diverse and adapted to each application.

EP 2 942 537 A1 shows a radial foil bearing with three corrugated foils and an almost circumferential top foil. The corrugated foils are each hooked with a hook-shaped end into their own slot in the outer ring and the top foil is inserted into one of the slots with both ends resting against one another.

EP 3 387 275 A1 shows a radial foil bearing with three packs consisting of top foil and corrugated foil. Each pack is inserted into a slot in the outer ring at each end of the foils.

CN 209 990 776 U shows a radial foil bearing in which both the corrugated foil and the top foil are designed to be almost completely circumferential and each have an angled end with which both foils are inserted into a common slot. This connection is then secured with a screw in a clamping manner.

It has proven problematic to arrange the foils economically in order to optimize the functional load-bearing capacity.

### SUMMARY

The present disclosure provides a design for a radial foil bearing which permits an economical arrangement of the foils and improves the radial foil bearing with regard to its function.

Example aspects broadly comprise a radial foil bearing having an outer ring, at least one corrugated foil and at least one top foil. The corrugated foil is arranged radially between the outer ring and the top foil. Three foil packs are formed from a corrugated foil and a top foil, which are arranged in succession along and on the inner circumferential surface of the outer ring. The radial foil bearing is operable in only one direction of rotation. A first end of each top foil is firmly connected to the outer ring and the second end of each top foil opposite to the first end is freely movable. The shaft to be supported can, within a defined angular range of the freely movable second end of the top foil, come into contact with the latter.

The firm connection of the first end to the outer ring is such that this first end is immovably connected to the outer ring. This can be achieved, for example, by resistance/spot welding or laser welding.

The foils of the radial foil bearing are formed as thin, resilient sheet metal strips and have a greater geometric expression in the circumferential direction of the radial foil bearing than in the axial direction of the radial foil bearing.

The disclosed radial foil bearing minimizes instabilities of a shaft to be supported at low speeds. In addition, the separation edge of the airflow is moved out of the load-bearing region with high pressure build-up. This allows the radial foil bearing to be operated at lower lift-off speeds.

The design of the radial foil bearing according to the disclosure improves the dynamic vibration behavior of a rotor of a compressor connected to the shaft to be supported and ensures smoother running of the compressor. These rotor-dynamic instabilities are minimized here by optimizing the radial foil bearing and the defined angular contact region.

The radial foil bearing according to the disclosure can be inserted with its outer ring into a receptacle of a compressor. The compressor is provided for supplying gases to a fuel cell, e.g., automotive, i.e., mounted in a mobile vehicle. Alternatively, such a compressor having the radial foil bearing according to the disclosure can be provided in a stationary fuel cell.

The radial foil bearing has a component-free enveloping circle on the inside, which serves as the maximum permissible installation space when joining with a shaft to be supported.

One embodiment of the disclosure provides that the contact between the shaft to be supported or the enveloping circle and the second end of the top foil is linear and extends in the axial direction. The position of the contact line is within one third of the circumferential length of the top foil from its free end, and the contact line is provided with a tolerance of +/−15% of the total circumferential extension length of the top foil. If the bearings are correspondingly fitted in the correct position, this contact also corresponds to the contact between the shaft and the top foil when the shaft is not rotating. A crescent-shaped gap is formed in the circumferential direction on both sides of this contact. When the speed of the shaft to be supported is increased, the load-bearing air cushion builds up in the crescent-shaped gap adjacent to the foil fastening. Due to the imprinted pressure and the flexibility of the foils, the contact turns into a gap with a planar expansion and almost constant radial gap height, which expands around the aforementioned angular range in both circumferential directions and forms the load-bearing gas/air cushion.

In one embodiment according to the disclosure, the top foil of one foil pack overlaps with the top foil of the foil pack following it in the circumferential direction at a radial distance. This overlap at a radial distance follows from a radial interleaving of two successive foils, in such a way that a first top foil is attached to the outer ring by a fastening tab at its first end. The fastening tab is arranged on a larger pitch circle than the bearing surface of the second top foil immediately following the first in the circumferential direction, on which the angular range according to the disclosure is arranged. This improves the circumferential load-bearing capacity of all successive angular ranges to the extent that the radial foil bearing can be made more compact in diameter.

This increases the circumferential bearing surface and also makes much better use of the installation space in the circumferential direction between the individual foil packs. The free (second) end of the top foil of a foil pack can overlap the fixed (first) end of the top foil of the circumferentially following foil pack—at a radial distance and without mutual contact or alternatively with planar contact.

The circumferential distance between two successive top foils is dimensioned in such a way that they do not come into contact with one another in operation—e.g., in the event of vibrations of the radial foil bearing or the shaft. However, the circumferential distancing is also such that the air cushion is prevented from rupturing—for example, the distance is based on the turbulence occurring at the end of the foil.

In an example embodiment of the radial foil bearing, the sum of the individual top foil arc lengths is greater than the inner circumference of the outer ring and thus the top foil of the one foil pack overlaps in contact with the top foil of the foil pack following it in the circumferential direction. This also improves the circumferential load-bearing capacity of all successive angular ranges to the extent that the radial foil bearing can be made more compact in diameter. For example, the second top foil, which covers the first top foil by means of the overlap to the center of the radial foil bearing, may be supported by the first top foil in this regard.

The center of the radius of the top foil, the contact between the shaft to be supported or the enveloping circle to the top foil and the bearing center of the radial foil bearing lie on an imaginary straight line. In operation, the linear contact becomes the bearing surface between the top foil and the shaft to be supported, as described at the outset.

Furthermore, the center of the radius of the top foil along this straight line can be eccentric to the bearing center of the radial foil bearing by 0.5% to 7% of the shaft radius. Thus, the top foil radius is correspondingly larger than the enveloping circle radius. Due to the geometrical design described above, a crescent-shaped gap is formed between the shaft and the top foil between the foil fastening point and the contact line between the enveloping circle and the top foil. The resulting crescent shape represents a form of a wedge gap, through which the air pressure required to lift the shaft from the top foil is already formed at lower speeds and even a slight radial deflection of the corrugated foil in the contact region is sufficient to form a large-area and thus load-bearing bearing surface. The so-called idle speed of fuel cell compressors can be reduced by the described geometry and thus a reduction in consumption can be achieved.

The “outer ring” in the context of the disclosure can be inserted into a housing as a separate component—as an “outer component”- or be formed integrally with the housing, so that the outer ring formed integrally with the housing is present as a housing bore. In the context of the disclosure, the multi-piece design (“outer component”) and the one-piece or integral design (“housing bore”) are combined under the term “outer ring”. One feature of the radial foil bearing is, in this regard, that the shaft to be supported or the enveloping circle contacts the foil pack or the top foil in a defined angular range.

The disclosed bearing improves the quality of the load-bearing capacity itself as well as the support of the shaft to be supported. This includes a centric positioning of the shaft in the static state, low lift-off speed, high load-bearing capacity in operation, and good dynamic rotor stability over the entire speed range of the compressor. If several of these foil packs are positioned over the inner circumference of the inner circumferential surface of the outer ring, three foil packs or more improve the centric position of the shaft in the static state and improve the dynamic rotor stability by allowing the shaft to be supported at several circumferential points, thus reducing its range of motion.

The radial foil bearing, with three foil packs arranged in succession in the circumferential direction, can only move in one direction of rotation—and is thus designed to be unidirectional. Reversing the direction of rotation is not possible, e.g., during operation, and is not intended. Due to its design, the radial foil bearing according to the disclosure allows for only one direction of shaft rotation. This includes a directional installation of the radial foil bearing so that the direction of rotation of the shaft to be supported corresponds to the operating direction of rotation of the radial foil bearing.

The radial foil bearing may be provided with a marking indicating the permissible direction of rotation in which the radial foil bearing is to be operated and is also to be installed in a receptacle with this information. Alternatively or in addition, a marking can indicate the location/position of the angular range according to the disclosure, such that the radial foil bearing can be inserted in a circumferential position in the receptacle so that the shaft to be supported finds contact in one of the angular ranges of the radial foil bearing according to the disclosure by means of its weight force when at a standstill.

### BRIEF DESCRIPTION OF THE DRAWINGS

An exemplary embodiment of the disclosure is described in more detail using the following figures. In the figures:

FIG. 1 shows a radial foil bearing according to an example embodiment: and

FIG. 2 shows a detail view of the radial foil bearing of FIG. 1.

### DETAILED DESCRIPTION

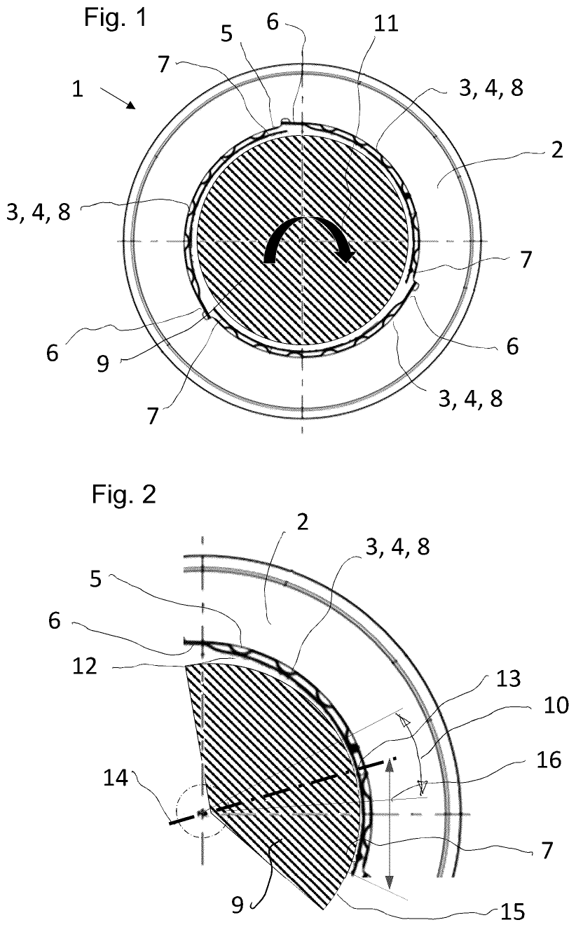

FIG. 1 shows a radial foil bearing 1 having an outer ring 2, a corrugated foil 3 and a top foil 4. The corrugated foil 3 and the top foil 4 form a foil pack 8. Three foil packs 8 are successively patterned around the circumference of the outer ring 2 and are arranged at a regular distance to one another. In this regard, the corrugated foil 3, which has a corrugated shape when viewed in the circumferential direction of the radial foil bearing 1, is in contact with an inner circumferential surface 5 of the outer ring 2. On the side of the corrugated foil 3 opposite the outer ring 2, the top foil 4 is in contact with the corrugated foil 3. The corrugated shape of the corrugated foil 3 causes the top foil 4 to deflect towards the outer ring 2, i.e., the radial expansion of the corrugated foil 3 is reduced by the deflection. This deflection lengthens the dimension of the corrugated foil 3 in the circumferential direction.

Each foil pack 8 has its top foil 4 and its corrugated foil 3 firmly connected to the outer ring 2 at a common first end 6. The other, second end 7 of the foil pack 8 and thus also of its foils 3, 4 is movable in the circumferential direction and in the radial direction. However, the second end 7 is in contact with the inner circumferential surface 5 of the outer ring 2—the top foil 4 indirectly via the corrugated foil 3 and the corrugated foil 3 itself directly on the outer ring 2.

The direction of rotation 11 of the shaft 9 to be supported is shown clockwise, i.e., an imaginary fixed point on the outer circumference of the shaft 9 first passes the fixed first end 6 of a foil pack 8 and then, as rotation progresses, the associated free end 7 of this foil pack 8. Three foil packs 8 are arranged with a circumferential offset of almost 120° inside the outer ring 2.

In the illustration shown in FIG. 1, the shaft 9 “floats” in the radial foil bearing 1 due to the schematic representation of the arrangement. In reality, when the shaft 9 is at a standstill, the shaft 9 is in contact 13 with one of the foil packs 8, e.g., with the associated top foil 4, due to its weight force, as shown more clearly in FIG. 2. This contact 13 may be arranged at a “six o'clock position” and within the angular range 10 according to the disclosure, contrary to the illustrations in FIGS. 1 and 2. If the shaft 9 is rotated and the state is changed from standstill to operation, then the wedge gap 12 shown in FIG. 2 is formed, leading to gas pressure build-up between the shaft 9 and the top foil 4 and allowing for the shaft 9 to lift off from the top foil 4 in the radial direction in the region of the linear contact 13. The flexible top foil 4 and the corrugated foil 3 form a planar and load-bearing gas/air cushion.

The contact 13 according to the disclosure lies within the angular range 10. The center of the angular range 10 is located away from the free end 7 of the delimiting edge of the top foil 4 opposite to the direction of rotation 11 by one third of the top foil circumference in radians. The limits of the angular range 10 are, in each case, 15% of the top foil circumference in radians away from this center on both sides.

In addition, according to FIG. 2, it is shown that the contact 13, the center of the radial foil bearing 1 and the center of the radius of the top foil 4, with which the contact 13 to the shaft 9 or the enveloping circle 15 is made, lie on a common straight line 14. The crescent-shaped gap 12 can thus be formed over an extension of ⅔ of the entire circumferential length of the top foil 4.

The linear contact 13 has an absolute value in radians 16 from the free end 7, which is equal to one third of the circumferential length of the top foil 4. The angular range 10 is formed around this contact 13, which is provided as the permissible region for the linear contact 13.

### REFERENCE NUMERALS

1 Radial foil bearing
2 Outer ring
3 Corrugated foil
4 Top foil
5 Inner circumferential surface
6 First end (fixed)
7 Second end (free)
8 Foil pack
9 Shaft
10 Angular range
11 Direction of rotation
12 Crescent-shaped gap
13 Contact shaft/top foil
14 Straight line
15 Enveloping circle
16 Absolute value in radians/distance from free end

1. A radial foil bearing for supporting a shaft, comprising:
an outer ring comprising an inner circumferential surface;
and
three foil packs, each formed from a corrugated foil and a top foil arranged in succession over the inner circumferential surface, each corrugated foil arranged radially between the outer ring and a respective top foil,
wherein:
the radial foil bearing is operable in only one direction of rotation, wherein a first end of each top foil is firmly connected to the outer ring and a second end of each top foil, opposite to the first end, is freely movable,
the shaft can contact the second end of each top foil within an angular range of the second end, or an enveloping circle of the radial foil bearing can contact each one top foil within the angular range, and
the top foil of one of the three foil packs overlaps with the top foil another one of the three foil packs following the one of the three foil packs in a circumferential direction at a radial distance.

2. The radial foil bearing according to claim 1, wherein:
the contact between the shaft or the enveloping circle and the second end of each top foil is linear and extends in an axial direction.

3. The radial foil bearing according to claim 1, wherein:
a sum of the individual top foil arc lengths is greater than a circumferential length of the inner circumference, and
the top foil of the one of the three foil packs overlaps in contact with the top foil of the another one of the three foil packs.

4. The radial foil bearing according to claim 1, wherein:
a center of a radius of the one of the three top foils, the contact between the shaft or the enveloping circle with each top foil, and a bearing center of the radial foil bearing lie on an imaginary straight line.

5. The radial foil bearing according to claim 4, wherein:
the center of the radius of the top foil is at a distance from a center of the enveloping circle of 0.5% to 7% of a radius of the enveloping circle, and the radius of the top foil is correspondingly larger than the radius of the enveloping circle.

6. The radial foil bearing according to claim 1, wherein:
the contact between the shaft or the enveloping circle and each top foil is arranged in a region of one third of a total circumferential length of each top foil, wherein the region extends from the second end of each top foil and forms the angular range.

7. The radial foil bearing according to claim 6, wherein:
the angular range is located at a distance from the free end of each top foil of the absolute value in radians corresponding to one third of a top foil circumference minus 15% of the top foil circumference and extends therefrom by the absolute value in radians of 30% of the top foil circumference.

8. The radial foil bearing of claim 1, wherein:
the radial foil bearing has at least one installation marking which enables installation in a correct position according to an effective direction of a weight force of the shaft and at least one of the contacts of the radial foil bearing.

9. A radial foil bearing operable in a single rotational direction, the radial foil bearing comprising:
an outer ring; and
a plurality of foil packs, each foil pack comprising a top foil and a corrugated foil arranged radially between the outer ring and the top foil, each top foil comprising:
a first end fixed to the outer ring; and
a second end, opposite the first end, that is freely movable and overlaps a circumferentially adjacent top foil, wherein:
a predetermined angular range of the second end is arranged to contact a shaft.

10. The radial foil bearing of claim 9, wherein the predetermined angular range of the second end is arranged to contact the shaft with a line contact extending in an axial direction.

11. The radial foil bearing of claim 9, wherein:
the outer ring comprises an inner circumference;
each of the top foils comprises an arc length; and
a sum of the arc lengths is greater than the inner circumference.

12. The radial foil bearing of claim 9, wherein:
each of the top foils is formed in an arc and comprises a center; and
a contact point between each predetermined angular range and the shaft, and the center, are arranged on an imaginary straight line.

13. The radial foil bearing of claim 9 wherein the predetermined angular range extends from the second end to one third of a circumferential length of the top foil.

14. The radial foil bearing of claim 9 further comprising an installation marking designating a rotational direction and a contact region for the shaft.
